(19) United States
(12) Patent Application Publication
(10) Pub. No.: US 2005/0257225 A1
(43) Pub. Date: Nov. 17, 2005

(54) Office automation device and method of installing, reinstalling, and upgrading a driver thereof

(76) Inventors: In-sung Choi, Seoul (KR); Chan-sup Kim, Metropolitan-city (KR); Yang-moon Kim, Yongin-si (KR)

Correspondence Address: STANZIONE & KIM, LLP, 919 18TH STREET, N.W., SUITE 440, WASHINGTON, DC, 20006, US

(21) Appl. No.: 11/121,097

(22) Filed: May 4, 2005

(30) Foreign Application Priority Data
May 14, 2004 (KR) 2004-34383
Jul. 28, 2004 (KR) 2004-59389

(51) Int. Cl. G06F 13/00

(52) U.S. Cl. 719/321

(57) ABSTRACT

An office automation (OA) device and methods of installing, reinstalling, and upgrading a driver of the OA device. The OA device includes a class information storage unit to store class information based on which a host device identifies the OA device and to output class information when being accessed by the host device; an program storage unit to store a driver program and a driver installation program for the OA device; and a control unit to control the host device to access the program storage unit when the class information read from the class information storage unit by the host device is a CD-ROM class, to control the OA device to perform inherent functions of the OA device when the class information is an inherent class of the OA device, and to change the class information set in the class information storage unit to a predetermined class in response to completion of installation of the OA device driver or an external input. The method of installing an OA device driver stored in an OA device in a host device connected to the OA device includes installing the OA device driver in the host driver by enabling the OA device to be recognized a class different from an inherent class of the OA device.

### CROSS-REFERENCE TO RELATED APPLICATIONS

This application claims the benefit of Korean Patent Application No. 2004-34383, filed on May 14, 2004, and the benefit of Korean Patent Application No. 2004-59389, filed on Jul. 28, 2004, in the Korean Intellectual Property Office, the disclosures of which are incorporated herein in their entirety by reference.

### BACKGROUND OF THE INVENTION

1. Field of the Invention

The present general inventive concept relates to an office automation (OA) device of a host device, and more particularly, to an OA device and a method of installing, reinstalling, and upgrading a driver thereof, by which the driver of the OA device is installed without a portable storage medium storing an OA device driver program.

2. Description of the Related Art

An OA device of a host device and particularly a printer or a multifunction device is a device that is connected to and driven by the host device. To enable the host device to drive the printer or the multifunction device, a driver program is needed. Conventionally, the driver program is provided to users by distributing portable storage media such as CD-ROMs or a floppy disk storing the driver program to customers purchasing a printer or a multifunction device. Then, a user can operate the printer or the multifunction device by installing the driver program stored in a portable storage medium.

In a widely used approach for installing a driver for driving a printer or a multifunction device, the driver is installed in a host device using a driver program stored in a portable storage medium such as a CD-ROM or a floppy disk provided together with the printer or the multifunction device. In detail, an OA device, such as a printer or a multifunction device, is connected to a host device. Next, a storage medium storing a driver program is loaded into the host device. Next, an execution file such as “CD AutoRun” or “Setup.exe” is driven and the driver program corresponding to a current model of the OA device is installed in the host program.

In another approach, a user downloads a driver program from a web site provided by a vendor. In detail, the user accesses the web site of the vendor selling an OA device, moves to a driver program download page on the web site, searches for a driver program corresponding to a model of the OA device, selects a type of an operating system (OS) and language used in a host device to which the driver program is downloaded, and downloads the driver program. After the download is completed, a driver for the OA device is installed in the host device.

In still another approach, an existing driver is reinstalled. Here, the existing driver is restored on a host device.

However, in the approach of installing a driver using a driver program stored in a portable storage medium provided together with a printer or a multifunction device, a user cannot install the driver if he/she has lost the portable storage medium.

In the approach of downloading a driver program from a web site of a vendor, if a user is not familiar with a computer environment, the user may have difficulty installing the driver and therefore may be inconvenienced. In other words, a series of steps of accessing the web site, searching for a driver program corresponding to a current model, downloading the driver program, and executing the driver program stored in a host device may be difficult and inconvenient for users unfamiliar with computer operations.

In the approach of reinstalling an existing driver, the driver can be installed only when the driver provides a restoration and reinstallation function.

Meanwhile, a driver program may be provided within a printer or a multifunction device. In other words, there is an OA device having a driver therein (e.g., a printer with driver), which automatically installs an OA device driver (e.g., a printer driver) in a host device. When a user connects a printer with a driver to a host device, the host device recognizes the printer with a driver. When the connection of the printer with a driver is recognized, the printer driver within the printer is uploaded to and installed in the host device. Then, the host device can print data through the printer driver installed therein.

However, the printer with the driver has only one version of a driver. When the printer with the driver has a particular version of the driver in a printer memory, the particular version cannot be updated with a different version of the driver, and therefore, the different version of the driver cannot be installed. In other words, since the conventional printer with the driver has a printer driver supporting a particular OS version, when the OS of a host device is upgraded, the printer driver cannot be installed automatically because the OS of the host device is different from an OS supported by the printer driver.

Accordingly, when a driver stored in a printer supports a lower version of the OS, e.g., Windows 95, the driver cannot be used on a host device supporting a higher version, e.g., Windows XP. Therefore, enabling an OA device such as a printer or a multifunction device always having a latest version of a driver is desired.

### SUMMARY OF THE INVENTION

The present general inventive concept provides a method of installing and reinstalling an office automation (OA) device driver by applying the concept of an external storage device to an OA device, such as a printer or a multifunction device, such that the OA device operates in two modes in which the OA device is recognized as an inherent OA device class performing the fundamental functions of the OA device and as a CD-ROM class functioning as an independent external storage device containing a driver installation program, respectively, so that a user can install the OA device driver without a separate storage device, such as a CD-ROM or a floppy disk, thereby increasing the user's convenience and satisfaction.

The present general inventive concept also provides the OA device that operates in two modes.

The present general inventive concept also provides a method and apparatus to upgrade a driver in an OA device, such as a printer or a multifunction device, having a driver therein, by which when a new driver is successfully installed in a host device or an OA device is newly connected to the host device, the driver installed in the host device is installed in a memory of the OA device if a version of the driver in the host device is higher than a version of the driver in the memory of the OA device so that the OA device can always have a latest version of the driver.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of installing an OA device driver stored in an OA device into a host device connected to the OA device. The method includes installing the OA device driver into the host driver by enabling the OA device to be recognized as a class different from an inherent class of the OA device. The installing of the OA device driver includes in response to an external input requesting reinstallation of the OA device driver, changing a class of the OA device to the class different from the inherent class of the OA device; and installing the OA device driver in the host device using a driver installation program when the class of the OA is changed.

The foregoing and/or other aspects and advantages of the present general inventive concept are also achieved by providing a method of installing an OA device driver stored in an OA device into a host device connected to the OA device. The method includes when the OA device is connected to the host device, reading class information set in the OA device using the host device; when the class information is set to a CD-ROM class, executing a driver installation program stored in the OA device using the host device to install the OA device driver into the host device; when the class information is set to an inherent class of the OA device, changing the class information to the CD-ROM class, and executing a driver installation program stored in the OA device using the host device to install the OA device driver into the host device; and changing the class information to the inherent class of the OA device.

The foregoing and/or other aspects and advantages of the present general inventive concept are also achieved by providing a method of reinstalling an OA device driver stored in an OA device into a host device connected to the OA device. The method includes in response to an external input requesting reinstallation of the OA device driver, changing class information of the OA device to a CD-ROM class; executing a driver installation program stored in the OA device using the host device to install the OA device driver into the host device; and when the reinstallation of the OA device driver is completed, changing the class information of the OA device to an inherent class of the OA device.

The foregoing and/or other aspects and advantages of the present general inventive concept are also achieved by providing an OA device which is connected to a host device and driven by an OA device driver installed in the host device. The OA device includes a class information storage unit to store class information which can be recognized by the host device and to output class information when being accessed by the host device; a program storage unit to store a driver program and a driver installation program for the OA device; and a control unit to control the host device to access the program storage unit when the class information read from the class information storage unit by the host device is a CD-ROM class, to control the OA device to perform inherent functions of the OA device when the class information is an inherent class of the OA device, and to change the class information set in the class information storage unit to a predetermined class in response to completion of installation of the OA device driver or an external input. The OA device may be one among a printer, copier, scanner, a fax machine, and a digital copier. The driver installation program may install the device driver program stored in the program storage unit into the host device when the driver installation program is executed. The inherent class of the OA device may be a printer class. The control unit may include a mode controller to control the host device to execute the driver installation program stored in the program storage unit when the class information is read and recognized as the CD-ROM class and to control the OA device to function as a printer when the class information is read and recognized as the printer class; and a class changer to change the class information from the CD-ROM class to the printer class when the driver program is installed in the host device and to change the class information to a predetermined class in response to an external input. The external input may include graphic user interface (GUI) providing a menu including an item for reinstallation of the driver program or may be a one-touch button for class change. The program storage unit may be one among a read only memory (ROM) and flash memory within the OA device, and a portable storage device and a memory card, which are able to be interfaced with the OA device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates the structure of a system using a method of installing and reinstalling an office device (OA) device driver according to an embodiment of the present general inventive concept;

FIG. 2 is a flowchart of a method of installing an OA device driver according to an embodiment of the present general inventive concept;

FIG. 3 is a flowchart of a method of reinstalling an OA device driver according to an embodiment of the present general inventive concept;

FIG. 4 is a block diagram of a system using an OA device according to an embodiment of the present general inventive concept;

FIG. 5 is a detailed block diagram of a control unit shown in FIG. 4;

FIGS. 6A and 6B illustrate examples of an external input to change class information in a class information storage unit into predetermined class information;

FIG. 7 is a flowchart of a method of initially installing a device driver program according to an embodiment of the present general inventive concept;

FIG. 8 is a flowchart of a method of reinstalling an OA device driver program according to an embodiment of the present general inventive concept;

FIG. 9 is a block diagram of a system using a method and apparatus to upgrade a driver stored in an OA device according to an embodiment of the present general inventive concept;

FIG. 10 is a block diagram of an apparatus j to upgrade a driver stored in an OA device according to an embodiment of the present general inventive concept; and

FIG. 11 is a flowchart of a method of upgrading a driver stored in an OA device according to an embodiment of the present general inventive concept.

### DETAILED DESCRIPTION OF THE PREFERRED EMBODIMENTS

Hereinafter, preferred embodiments of the present general inventive concept will be described in detail with reference to the attached drawings in which like reference numerals denote like members. The basic concept of the present general inventive concept will be set forth first. An internal storage area is provided within an office automation device, such as a printer or a multifunction device, to store a driver program and a driver installation program. The concept of an external storage device is applied so that the OA device operates in two modes in which the OA device is recognized as an inherent OA device class that performs the fundamental functions of the OA device and as a CD-ROM class that operates as an independent external storage device containing a driver installation program, respectively, thereby allowing a user to install/reinstall a driver without a separate portable storage device such as a CD-ROM.

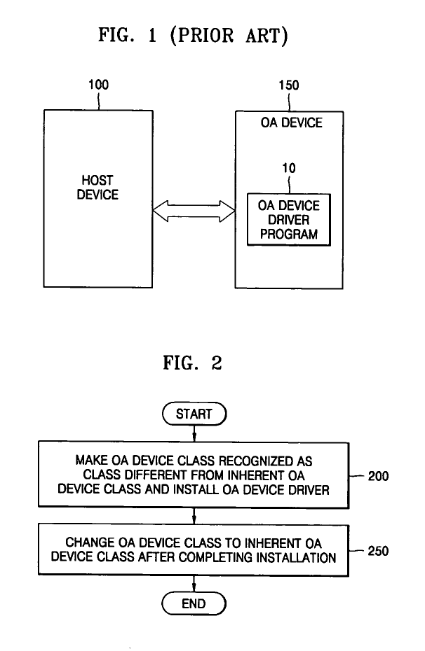

FIG. 1 illustrates the structure of a system using the various embodiments of the present general inventive concept. The system includes a host device 100 and an OA device 150 connected to the host device 100. An OA device driver program 10 is stored in the OA device 150. Various embodiments of the present general inventive concept provide a method of installing and reinstalling the OA device driver program 10 stored in the OA device 150 in the host device 100.

A method of installing and reinstalling an OA device driver according to an embodiment of the present general inventive concept will be described first.

FIG. 2 is a flowchart of a method of installing an OA device driver according to an embodiment of the present general inventive concept. In operation 200, the OA device 150 is made to be recognized by the host device 100 as a predetermined class, e.g., a CD-ROM class, different from an inherent OA device class, and an OA device driver in the OA device is installed in the host device 100. When the OA device driver is completely installed in the host device 100, OA device class information is changed into the inherent OA device class in operation 250.

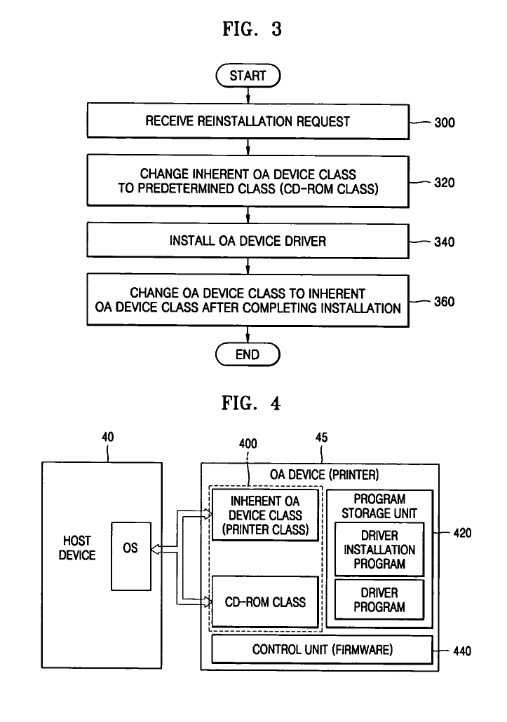

FIG. 3 is a flowchart of a method of reinstalling an OA device driver according to an embodiment of the present general inventive concept. In operation 300, OA device reinstallation is requested through an external input. In operation 320, in response to the request, an inherent OA device class set in the OA device 150 is changed to a predetermined class, e.g., a CD-ROM class. In operation 340, the OA device driver program 10 is reinstalled in the host device 100 by a driver installation program executed in response to the above-described class change. After the completion of the reinstallation, current OA device class information set to the CD-ROM class is changed to the inherent OA device class, in operation 360. The OA device may be a printer, a copy machine, a scanner, a fax machine, or a digital copier.

FIG. 4 is a block diagram of a system using an OA device according to an embodiment of the present general inventive concept. The system includes a host device 40 and an OA device 45 connected to the host device 40. A device driver program to be installed in the host device 40 is stored in the OA device 45. The OA device 45 may include a class information storage unit 400, a program storage unit 420, and a control unit 440.

The class information storage unit 400 stores class information, and when accessed by the host device 40, can output currently set class information. The class information is used by the host device 40 to identify the OA device 45 when the OA device 45 is connected to the host device 40. Generally, devices such as a mouse, a keyboard, a hard disk, a floppy disk, a CD-ROM, a printer, a copier, a scanner, a fax machine, and digital devices may be connected to the host device 40, and the host device 40 can identify each device based on class information of the device. In embodiments of the present general inventive concept, the OA device 45 can be a printer, and a “CD-ROM class” indicating a CD-ROM and a “printer class” indicating a printer are stored as the class information. In other words, the printer includes both of the “printer class” set to perform printing and the “CD-ROM class” set to install a printer driver in the host device 40.

The program storage unit 420 stores an OA device driver program and a driver installation program. In embodiments of the present general inventive concept, the program storage unit 420 can be physically included in a printer, but since the program storage unit 420 is accessed by the host device 40 when the class information is set to the CD-ROM class, the program storage unit 420 is logically recognized by the host device 40 as a separate OA device. When the host device 40 executes the driver installation program, the device driver program is read from the program storage unit 420 and installed in the host device 40. Accordingly, when the host device 40 accesses the program storage unit 420, it recognizes the OA device 45 as a CD-ROM and thus executes the driver installation program. As a result, a device driver is installed in the host device 40. The program storage unit 420 may be implemented by a ROM or a flash memory of the OA device 45 or by a portable storage device or a memory card that can be interfaced with the OA device 45.

When the host device 40 reads the class information set to the CD-ROM class from the class information storage unit 400, the control unit 440 controls the host device 40 to access the program storage unit 420. When the host device 40 reads the class information set to the inherent OA device class, i.e., the printer class in this embodiment, the control unit 440 controls the OA device 45 to function as a printer. When an OA device driver, i.e., a printer driver in this embodiment, is completely installed in the host device or when there is an external input, the control unit 440 may change the class information set in the class information storage unit 400.

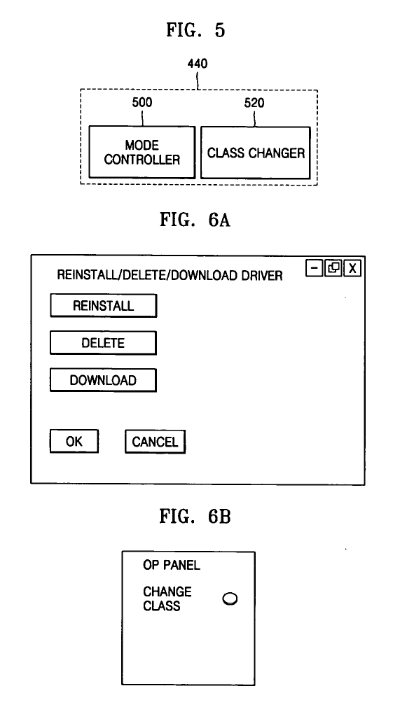

FIG. 5 is a detailed block diagram of the control unit 440 shown in FIG. 4. The control unit 440 can include a mode controller 500 and a class changer 520. When the class information is read and recognized as the CD-ROM class, the mode controller 500 controls the host device 40 to execute the driver installation program stored in the program storage unit 420. When the class information is read and recognized as the printer class, the mode controller 500 controls the OA device 45 to operate as a printer.

When the OA device driver program, i.e., the printer driver program, is completely installed in the host device 40, the class changer 520 changes the class information to the printer class. When there is an external input, the mode changer 520 changes the class information to the CD-ROM class.

The predetermined external input can be provided to a user through a graphic interface, as shown in FIG. 6A, so that the user can change the class. For example, if the user selects a “Reinstall” item through a graphic user interface (GUI), the class changer 520 generates a class change command and changes the current class set in the class information storage unit 400 to the “CD-ROM class.” Alternatively, a one-touch button for class change, i.e., a “Change class” button may be provided on an OP panel of the printer.

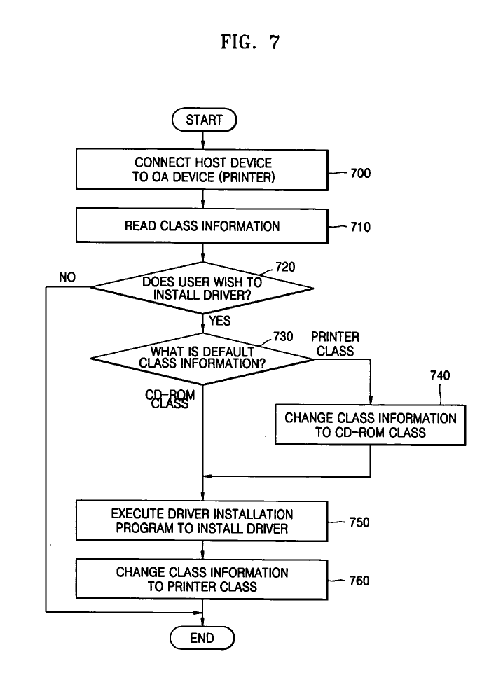

FIG. 7 is a flowchart of a method of initially installing a device driver program according to an embodiment of the present general inventive concept. The operation of an OA device and a method of installing a driver of the OA device will be described in detail with reference to FIG. 7.

In an embodiment of the present general inventive concept, the OA device has plural types of class information and has stored therein a device driver program and a driver installation program. For example, when a printer driver is installed in the OA device, a CD-ROM class can be set as class information of a printer, and the program storage unit 420 of the OA device is accessed. Alternatively, a printer class can be set as the class information, and typical printer functions are performed. The program storage unit 420 stores a printer driver program and a driver installation program.

Referring to FIGS. 4, 5 and 7, in operation 700, a host device 40 is connected to an OA device 45. In operation 710, the host device 40 reads the class information storage unit 400 and recognizes current class information of the OA device 45. Here, the host device 40 may read the class information through an operating system (OS). In operation 720, it is determined whether a user wishes to install a driver of the OA device 45 into the host device 40. If it is determined that the user wishes to install the OA device driver into the host device 40, the type of class information of the OA device 45 is determined, i.e., default class information set when the OA device 45 is manufactured, in operation 730. If the class information is determined to be the CD-ROM class, the host device 40 executes the driver installation program stored in the program storage unit 420 to install the device driver program therein, in operation 750. Here, the host device 40 is allowed to access the program storage unit 420 by the mode controller 500 of the control unit 440. When the OA device 45, e.g., a printer, is recognized as the CD-ROM class based on the class information, even if the OA device 45 is physically a printer, the host device 40 logically recognizes the printer as a CD-ROM, and thus executes the driver installation program stored in the program storage unit 420. Here, the program storage unit 420 of the printer stores a driver installation CD image to drive a driver, and the driver installation CD image is automatically executed through “AutoRun” when the printer operates as the CD-ROM class.

After the driver program is installed in the host device 40, in operation 760 the class information of the OA device 45 is changed to a predetermined class, i.e., the printer class in this embodiment, by the class changer 520 of the control unit 440. The class change performed by the control unit 440 may be carried out by a mode change command generated by firmware of the printer.

If the default class information of the OA device 45 is detected as the inherent class of the OA device 45, i.e., the printer class, the class information of the OA device 45 is changed to the CD-ROM class in operation 740. Thereafter, operation 750 is performed. Meanwhile, if it is determined that the user does not wish to install the driver of the OA device 45 in operation 720, this initial installation method ends.

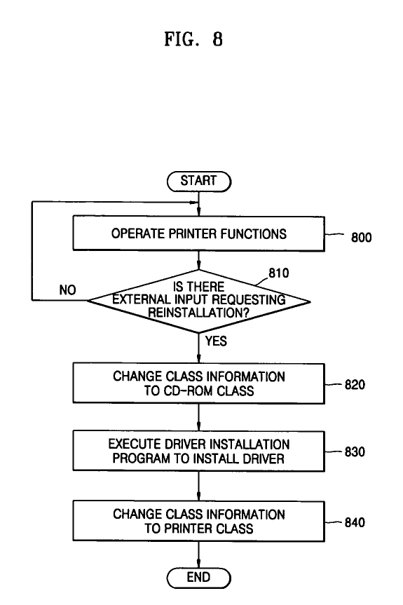

FIG. 8 is a flowchart of a method illustrating reinstalling of a driver program of an OA device 45, e.g., a printer, according to an embodiment of the present general inventive concept. A method of reinstalling a driver of a printer will be described in detail with reference to FIG. 8.

In operation 800, the printer is performing inherent functions as a printer. In operation 810, it is determined whether there is an external input requesting reinstallation of a driver. If it is determined that there is the external input requesting reinstallation, a printer class set as the class information in the class information storage unit 400 is changed to a CD-ROM class in operation 820. The external input requesting reinstallation may be made by a user pressing a one-touch button for class change provided on a panel. In response to the external input, the class changer 520 of the control unit 440 changes the class information. Alternatively, the external input requesting reinstallation may be made by the user through a GUI. Then, the host device 40 generates and transmits a corresponding command to the class changer 520 of the control unit 440, which changes the class information in response to the command.

After the class information is changed to the CD-ROM class, the host device 40 executes a driver installation program stored in the program storage unit 420 of the printer to install the driver program of the printer therein, in operation 830. If the printer is recognized as the CD-ROM class, even if the printer is physically a printer, the host device 40 logically recognizes the printer as an external storage device, i.e., a CD-ROM. As a result, the host device 40 automatically executes an AutoRun program of a driver installation CD image stored in the program storage unit 420.

After the driver program is installed in the host device 40, in operation 840 the class information of the printer is changed to a predetermined class, i.e., the printer class, by the class changer 520 of the control unit 440. The class change performed by the control unit 440 may be carried out by a mode change command generated by firmware of the printer.

Meanwhile, to upgrade a driver to a latest version in the program storage unit 420 of an OA device 45, e.g., a printer or a multifunction device, the class information may be changed to the CD-ROM class and the latest version of the driver may be stored in the printer or the multifunction device through a copy operation.

Hereinafter, a method and apparatus to upgrade a driver stored in an OA device according to embodiment of the present general inventive concept will be described in detail with reference to the attached drawings.

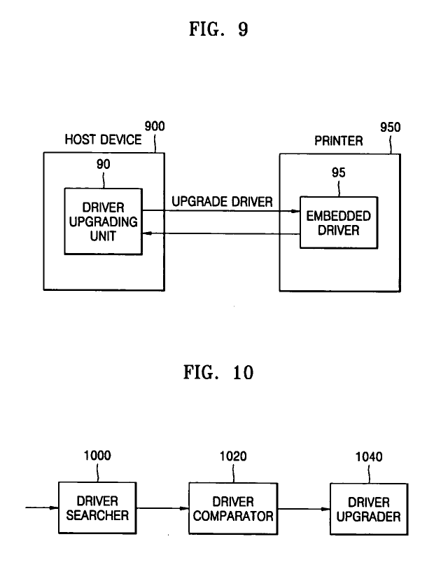

FIG. 9 is a block diagram of a system using a method and apparatus to upgrade a driver stored in an OA device according to embodiments of the present general inventive concept. The system includes a host device 900 and a printer 950 as the OA device.

The host device 900 includes a driver upgrading unit 90 to compare a driver 95 stored in the printer 950 with a new driver when the new driver is installed in the host device 900. The driver upgrading unit 90 may be implemented by a particular application program. The printer 950 includes flash memory therein to store and upgrade the driver 95 stored in the printer 950.

FIG. 10 is a block diagram of an apparatus to upgrade a driver stored in an OA device according to an embodiment of the present general inventive concept. The apparatus includes a driver searcher 1000, a driver comparator 1020, and a driver upgrader 1040. The OA device may be a printer or a multifunction device. If the OA device is a multifunction device, a driver stored in the multifunction device may be a scanner driver.

The driver searcher 1000 searches the driver stored in the OA device when a new OA device is connected to the host device.

The driver comparator 1020 compares the driver stored in the OA device with a driver installed in the host device. Here, the driver comparator 1020 compares driver versions.

The driver upgrader 1040 upgrades the driver stored in the OA device. When the driver installed in the host device is newer than the driver stored in the OA device, the driver in the host device is stored in the OA device. As a result, the driver stored in the OA device is upgraded.

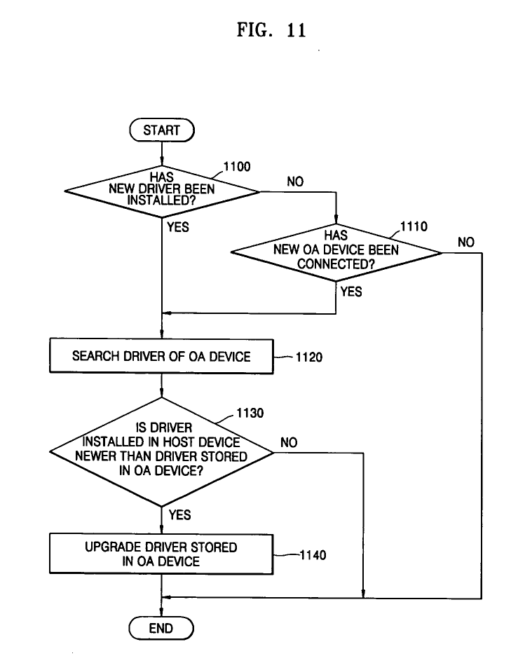

FIG. 11 is a flowchart of a method of upgrading a driver stored in an OA device according to an embodiment of the present general inventive concept. The operation of the apparatus shown in FIG. 10 (hereinafter, referred to as a “driver upgrading apparatus”) will be described with reference to FIGS. 10 and 11.

The driver upgrading apparatus operates in two situations: when a new driver is installed in a host device; and when a new OA device is connected to a host device.

The situation where a new driver is installed in a host device will be described first. For example, in a state where a driver stored in an OA device supports a Windows 95 OS and a driver installed in a host device is also used on the Windows 95 OS, a higher OS version, e.g., Windows XP, and a new driver supporting the Windows XP may be installed in the host device. In this situation, if the new driver is completely installed in the host device in operation 1100, the driver searcher 1000 accesses memory of the OA device and searches the driver stored in the OA device in operation 1120.

Next, the situation where a new OA device is connected to the host device will be described. If it is recognized that the new OA is connected to the host device in operation 1110, the driver searcher 1000 accesses memory of the OA device and searches the driver stored in the OA device in operation 1120.

After the driver stored in the OA device is searched, in operation 1130, the driver comparator 1020 compares the driver stored in the OA device with a driver installed in the host device. Here, it is preferable to compare driver versions.

If it is determined that a version of the driver installed in the host device is newer than a version of the driver stored in the OA device, the driver upgrader 1040 stores the driver installed in the host device in the OA device, e.g., in flash ROM of a printer, to upgrade the driver in the OA device in operation 1140.

When using an OA device and a method of installing/reinstalling a driver of the OA device according to an embodiment of the present general inventive concept, a user can easily install a driver for a current model of the OA device, e.g., a printer or a multifunction device, in a host device through a GUI or by pressing a one-touch button provided in the OA device. In other words, the OA device provides both of a driver installation function and an inherent device function, thereby increasing the user's convenience and satisfaction. In addition, reliability and convenience of the product can be increased and maintenance costs can be saved.

Conventionally, when a driver stored in an OA device supports a version of an OS, e.g., Windows 95, lower than an OS, e.g., Windows XP, used with a host device, the driver cannot be used with the host device. A method and apparatus of upgrading a driver stored in an OA device according to the embodiments of FIGS. 10 and 11 remove this problem and allow the driver stored in the OA device to be upgraded to a latest version of the driver installed in the host device. In other words, when a driver stored in the OA device is upgraded, the upgrade can be easily performed through a simple application.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of installing an office automation (OA) device driver stored in an OA device in a host device connected to the OA device, the method comprising:
installing the OA device driver in the host driver by enabling the OA device to be recognized as a class different from an inherent class of the OA device.

2. The method of claim 1, wherein the installing of the OA device driver comprises:
in response to an external input requesting reinstallation of the OA device driver, changing a class of the OA device to a class different from the inherent class of the OA device; and
installing the OA device driver in the host device using a driver installation program when the class of the OA is changed.

3. A method of installing an office automation (OA) device driver stored in an OA device in a host device connected to the OA device, the method comprising:
when the OA device is connected to the host device, reading class information set in the OA device using the host device;
when the class information is set to a CD-ROM class, executing a driver installation program stored in the OA device using the host device to install the OA device driver in the host device;
when the class information is set to an inherent class of the OA device, changing the class information to the CD-ROM class and executing a driver installation program stored in the OA device using the host device to install the OA device driver in the host device; and
changing the class information to the inherent class of the OA device.

4. A method of reinstalling an office automation (OA) device driver stored in an OA device in a host device connected to the OA device, the method comprising:
in response to an external input requesting reinstallation of the OA device driver, changing class information of the OA device to a CD-ROM class;
executing a driver installation program stored in the OA device using the host device to install the OA device driver in the host device; and
when the reinstallation of the OA device driver is completed, changing the class information of the OA device to an inherent class of the OA device.

5. An office automation (OA) device which is connected to a host device and driven by an OA device driver installed in the host device, the OA device comprising:
a class information storage unit to store class information which can be recognized by the host device and to output class information when being accessed by the host device;
a program storage unit to store a driver program and a driver installation program for the OA device; and
a control unit to control the host device to access the program storage unit when the class information read from the class information storage unit by the host device is a CD-ROM class, to control the OA device to perform inherent functions of the OA device when the class information is an inherent class of the OA device, and to change the class information set in the class information storage unit to a predetermined class in response to completion of installation of the OA device driver or an external input.

6. The OA device of claim 5, wherein the OA device is one among a printer, copier, scanner, a fax machine, and a digital copier.

7. The OA device of claim 5, wherein the driver installation program installs the device driver program stored in the program storage unit in the host device when the driver installation program is executed.

8. The OA device of claim 7, wherein the inherent class of the OA device is a printer class.

9. The OA device of claim 8, wherein the control unit comprises:
a mode controller to control the host device to execute the driver installation program stored in the program storage unit when the class information is read and recognized as the CD-ROM class and to control the OA device to function as a printer when the class information is read and recognized as the printer class; and
a class changer to change the class information from the CD-ROM class to the printer class when the driver program is installed in the host device and to change the class information to a predetermined class in response to an external input.

10. The OA device of claim 9, wherein the external input comprises graphic user interface (GUI) to provide a menu including an item for reinstallation of the driver program.

11. The OA device of claim 9, wherein the external input is a one-touch button for class change.

12. The OA device of claim 5, wherein the program storage unit is one selected from the group consisting of a read only memory (ROM) and flash memory within the OA device, and a portable storage device and a memory card, which are able to be interfaced with the OA device.

13. A method of upgrading a driver stored in an office automation (OA) device, the method comprising:
when the OA device is connected to the host device, searching the driver stored in the OA device;
comparing the driver searched in the OA device with the driver installed in the host device; and
when the driver installed in the host device is newer than the driver stored in the OA device, storing the driver installed in the host device in the OA device.

14. The method of claim 13, wherein the comparing of the drivers comprises comparing a version of the driver installed in the host device and a version of the driver stored in the OA device.

15. The method of claim 13, wherein the OA device is one selected from the group consisting of a copier, a scanner, a fax machine, and a digital copier.

16. An apparatus to upgrade a driver stored in an office automation (OA) device, the apparatus comprising:
a driver searcher to search the driver stored in the OA device when the OA device is newly connected to a host device;
a driver comparator to compare the driver stored in the OA device with the new driver installed in the host device; and
a driver upgrader to store the new driver installed in the host device in the OA device when the new driver installed in the host device is newer than the driver stored in the OA device.

17. The apparatus of claim 16, wherein the driver comparator reads a version of the driver stored in the OA device when connection of the OA device storing the driver therein is recognized and compares the version of the driver stored in the OA device with a version of the new driver installed in the host device.

18. A computer readable recording medium recording therein a program to execute the method of claim 13 on a computer.
